(19) United States
(12) Patent Application Publication
(10) Pub. No.: US 2009/0093564 A1
(43) Pub. Date: Apr. 9, 2009

(54) Method for forming cured product from photocurable composition and cured product

(75) Inventor: Takashi Oyanagi, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/287,119

(22) Filed: Oct. 6, 2008

(30) Foreign Application Priority Data
Oct. 4, 2007 (JP) 2007-260774

(51) Int. Cl. C08F 2/46; C08J 7/18

(52) U.S. Cl. 522/88; 427/508; 522/179; 522/182; 522/185

(57) ABSTRACT

A method for forming a cured product includes applying a photocurable composition to a base and irradiating the photocurable composition with light from a light source to cure the photocurable composition. The light source is at least one of a fluorescent lamp and a light-emitting diode. The photocurable composition contains a dendritic polymer, a polymerizable compound containing active hydrogen, a photopolymerization initiator, and a hindered amine light stabilizer.

### BACKGROUND

1. Technical Field

The present invention relates to a method for forming a cured product from a photocurable composition and a cured product produced by the method.

2. Related Art

In order to cure conventional photocurable compositions, a large energy density, 1 to 10 J/cm², is necessary. Therefore, a photocurable composition is cured in such a manner that the photocurable composition is irradiated with ultraviolet light from a large mercury lamp having a power consumption of about 0.5 to 10 kW and an irradiance of about 0.1 to 1 kW/cm² as disclosed in, for example, JP-A-2000-336295.

The mercury lamp has a low efficiency in converting energy to ultraviolet light because 50% or more of the energy consumed by the mercury lamp is dissipated as infrared light or as heat. If a base is irradiated with light from the mercury lamp, the base is thermally damaged because of the absorption of infrared light and/or visible light, heat transfer, and the like depending on the type of the base. This can cause the base to be irrepairably distorted. The use of a cooling unit for reducing thermal damage causes a problem in that a system including the cooling unit has a large size. Furthermore, strong ultraviolet light is harmful to humans and long-term exposure to ultraviolet light increases health risk; hence, tools, such as shielding plates, for blocking ultraviolet light need to be used.

### SUMMARY

An advantage of an aspect of the invention provides a method for forming a cured product. The method is capable of curing a photocurable composition with light emitted from a light source, such as a fluorescent lamp or a light-emitting diode (LED), having low energy consumption and low output power. Another advantage of an aspect of the invention provides a cured product produced by the method.

A method for forming a cured product according to the present invention includes a step of applying a photocurable composition to a base and a step of irradiating the photocurable composition with light from a light source to cure the photocurable composition. The light source is at least one of a fluorescent lamp and an LED. The photocurable composition contains a dendritic polymer, a polymerizable compound containing active hydrogen, a photopolymerization initiator, and a hindered amine light stabilizer (HALS).

According to the method, the photocurable composition can be cured in such a manner that the photocurable composition is irradiated with light from the fluorescent lamp or LED, which is a low output light source; hence, the base can be prevented from being thermally damaged. The method can be used to treat a base sensitive to heat and also can be used to bond a lens or a plastic material such as an acrylic plate, a polyvinyl chloride (PVC) film, or a PVC sheet to another material.

In the method, the photocurable composition may be applied to the base by an ink jet recording process.

In the method, the fluorescent lamp may be a non-white fluorescent lamp that amplifies a specific wavelength.

In the method, the fluorescent lamp may be at least one selected from the group consisting of a color fluorescent lamp, a black-light fluorescent lamp, and a photochemical fluorescent lamp.

In the method, the surface temperature of the base may be lower than 50° C. A material for forming the base may be selected from the group consisting of polyvinyl chloride, polyethylene terephthalate, an acrylic resin, and polycarbonate.

In the method, the photocurable composition may further contain a chain transfer agent containing active hydrogen.

A cured product is produced by the method.

### DESCRIPTION OF EXEMPLARY EMBODIMENTS

A method for forming a cured product according to the present invention includes a step of applying a photocurable composition to a base and a step of irradiating the photocurable composition with light from a fluorescent lamp or an LED to cure the photocurable composition. The photocurable composition contains a dendritic polymer, a polymerizable compound containing active hydrogen, a photopolymerization initiator, and a HALS.

Preferred embodiments of the present invention will now be described.

A photocurable composition according to an embodiment of the present invention is described below in detail.

### 1. Photocurable Composition

### 1.1 Dendritic Polymer

The photocurable composition of this embodiment contains a dendritic polymer which is a photoradically polymerizable compound. The dendritic polymer can be roughly categorized into the following six structures (see Keigo Aoi and Masaaki Kakimoto (supervisors), “Dendritic Polymers: World of High Functionalization Diversified by Multibranched Structures (Dendritic Kobunshi: Tabunki Kozo ga Hirogeru Koukinouka no Sekai)”, NTS Inc.):

I. Dendrimer,

II. Linear dendritic polymer,

III. Dendrigraft polymer,

IV. Hyperbranched polymer,

V. Star hyperbranched polymer, and

VI. Hypergraft polymer.

Structures I to III have a degree of branching (DB) of 1 and are defect-free, whereas Structures IV to VI are randomly branched and may have a defect. In particular, the dendrimer can carry reactive functional groups more densely or thickly arranged on the outermost surface thereof as compared to linear polymers generally used and therefore promises well as a functional polymer material. The hyperbranched polymer, the dendrigraft polymer, and the hypergraft polymer also can carry a large number of reactive functional groups arranged on the outermost surfaces thereof, though not so many as the dendrimer, and are excellent in curability.

Unlike conventional linear or branched polymers, the dendritic polymer has a three-dimensional repeating structure and is highly branched. Therefore, the dendritic polymer can be controlled to have lower viscosity as compared to linear polymers having substantially the same molecular weight as that of the dendritic polymer.

Examples of a method for synthesizing the dendritic polymer include a divergent method in which synthesis proceeds outward from the center and a convergent method in which synthesis proceeds toward the center from outside.

The dendritic polymer is preferably solid at room temperature and preferably has a number-average molecular weight of 1,000 to 100,000 and more preferably 2,000 to 50,000. When the dendritic polymer is not solid at room temperature, an image formed from the dendritic polymer is not well maintained. If the dendritic polymer has a molecular weight less than the above range, a fixed image formed from the dendritic polymer is brittle. When the dendritic polymer has a molecular weight greater than the above range, an ink containing the dendritic polymer is impractical in ejectability because the ink has excessively high viscosity even if the content of the dendritic polymer in the ink is reduced.

The dendritic polymer preferably contains radically polymerizable functional groups arranged on the outermost surface thereof. The presence of the radically polymerizable functional groups allows polymerization to proceed quickly.

Examples of the dendritic polymer include compounds described in paragraphs [0008] to [0021] of JP-A-2007-182535 and compounds described in paragraphs [0011] to [0024] of JP-A-2007-182536.

In the photocurable composition, the dendrimer, the hyperbranched polymer, the dendrigraft polymer, and the hypergraft polymer may be used alone or in combination.

A specific example of the dendritic polymer is Viscoat #1000 available from Osaka Organic Chemical Industry Ltd.

The content of the dendritic polymer in the photocurable composition is preferably about 3% to 30% and more preferably about 5% to 25% on a weight basis. When the dendritic polymer content is less than 3% by weight, the photocurable composition has insufficient curability. When the dendritic polymer content is greater than 30% by weight, the photocurable composition may be problematic in viscosity, dispersion stability, storage stability, and the like.

### 1.2 Polymerizable Compound Containing Active Hydrogen

The photocurable composition contains further contains a polymerizable compound containing active hydrogen. The active hydrogen-containing polymerizable compound serves as a polymerizable monomer. The use of the active hydrogen-containing polymerizable compound prevents oxygen from inhibiting polymerization and therefore allows the photocurable composition to have high curability.

The active hydrogen-containing polymerizable compound is one having a functional group containing active hydrogen. Examples of the active hydrogen-containing functional group include an amino group, an amide group, a hydroxyl group, a sulfone group, and a thiol group. The active hydrogen-containing polymerizable compound is not particularly limited except having the active hydrogen-containing functional group. The active hydrogen-containing polymerizable compound may be known one. Examples of the active hydrogen-containing polymerizable compound include ethylene glycol monoallyl ether, diethylene glycol monoallyl ether, trimethylol propane diallyl ether, trimethylol propane monoallyl ether, glycerin monoallyl ether, allyl glycidyl ether, pentaerythritol triallyl ether, hydroxybutyl vinyl ether, 2-hydroxyethyl methacrylate, 2-hydroxypropyl acrylate, and 4-hydroxybutyl acrylate.

The photocurable composition may contain a polymerizable oligomer containing active hydrogen instead of the active hydrogen-containing polymerizable compound. An example of the active hydrogen-containing polymerizable oligomer is a urethane oligomer described below.

The photocurable composition may further contain a photoradically polymerizable compound in addition to the active hydrogen-containing polymerizable compound. The photoradically polymerizable compound is not particularly limited and may be a known monofunctional, bifunctional, or multifunctional monomer. Alternatively, the photoradically polymerizable compound may be an oligomer.

The content of the active hydrogen-containing polymerizable compound in the photocurable composition is preferably about 30% to 95% and more preferably about 50% to 90% on a weight basis. When the content thereof is less than 30% by weight, the photocurable composition has low curability and therefore may be insufficiently cured to cause defects. When the content thereof is greater than 95% by weight, a cured product made from the photocurable composition has low strength and therefore is unsuitable for practical use.

### 1.3 Polymerization Initiator

The photocurable composition further contains a polymerization initiator, that is, a photopolymerization initiator for radical or cationic polymerization. The photopolymerization initiator is a compound that chemically changes due to the action of light or the synergy between the action of light and the electronic excitation of a sensitizing dye to produce at least one of a radical, an acid, and a base. The photopolymerization initiator can be selected from those sensitive to active rays such as 200-400 nm ultraviolet rays, far ultraviolet rays, g-lines, h-lines, i-lines, KrF excimer laser beams, ArF excimer laser beams, electron beams, X-rays, molecular beams, or ion beams.

Examples of the photopolymerization initiator include aromatic ketones, aromatic onium salts, organic peroxides, hexaarylbiimidazoles, ketoxime esters, borates, azinium salts, metallocenes, active esters, and carbon-halogen bond-containing compounds.

### 1.3.1 Aromatic Ketones

Preferred examples of the aromatic ketones include compounds having benzophenone or thioxanthone groups.

Other examples of the aromatic ketones include α-thiobenzophenone compounds, benzoin ether compounds, α-substituted benzoin compounds, benzoin derivatives, aroylphosphonic acid esters, dialkoxybenzophenones, benzoin ethers, a-amino benzophenones, p-di(dimethylaminobenzoyl)benzene, thio-substituted aromatic ketones, acylphosphine sulfide, acylphosphines, thioxanthones, and coumarins.

### 1.3.2 Aromatic Onium Salts

The aromatic onium salts contain Group-V, Group-VI, and Group-VII elements of the periodic table. In particular, the aromatic onium salts contain N, P, As, Sb, Bi, O, S, Se, Te, or I. Preferred examples of the aromatic onium salts include sulfonium salts, diazonium salts such as benzenediazonium salts that may have a substituent, diazonium resins such as diazodiphenylamine-formaldehyde resins, and N-alkoxypyridinium salts such as 1-methoxy-4-phenylpyridinium tetrafluoroborate.

### 1.3.3 Organic Peroxides

The organic peroxides cover almost all organic compounds each containing one or more oxygen-oxygen bonds. Examples of the organic peroxides include 3,3′,1,4,41-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,31,4,41-tetra(t-octylperoxycarbonyl)benzophenone, 3,3′,4,4′-tetra(t-cumylperoxycarbonyl)benzophenone, 3,3′,4,4′-tetra(t-isopropylperoxycarbonyl)benzophenone, and di-t-butyldiperoxy isophthalate.

### 1.3.4 Hexaarylbiimidazoles

Examples of the hexaarylbiimidazoles include lophine dimers such as 2,2′-bis(o-chlorophenyl)-4,41,5,51-tetraphenylbiimidazole, 2,2′-bis(o-bromophenyl)-4,4′,5,5′-tetraphenylbiimidazole, 2,2′-bis(o,p-dichlorophenyl)-4,41,5,51-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole, and 2,2′-bis(o-trifluorophenyl)-4,4′,5,5′-tetraphenylbiimidazole.

### 1.3.5 Ketoxime Esters

Examples of the ketoxime esters include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-p-toluenesulfonyloxyiminobutan-2-one, and 2-ethoxycarbonyloxyimino-1-phenylpropan-1-one.

### 1.3.6 Borates

Examples of the borates include compounds disclosed in U.S. Pat. No. 3,567,453.

### 1.3.7 Azinium Salts

Examples of the azinium salts include nitrogen-oxygen bond-containing compounds disclosed in JP-A-63-138345.

### 1.3.8 Metallocenes

Examples of the metallocenes include titanocenes disclosed in JP-A-2-4705 and iron-arene complexes disclosed in JP-A-1-152109.

Examples of the titanocenes include dicyclopentadienyl titanium dichloride, dicyclopentadienyl titanium bisphenyl, dicyclopentadienyl titanium bis-2,3,4,5,6-pentafluorophen-1-yl, dicyclopentadienyl titanium bis-2,3,5,6-tetrafluorophen-1-yl, dicyclopentadienyl titanium bis-2,4,6-trifluorophen-1-yl, dicyclopentadienyl titanium bis-2,6-difluorophen-1-yl, dicyclopentadienyl titanium bis-2,4-difluorophen-1-yl, dimethylcyclopentadienyl titanium bis-2,3,4,5,6-pentafluorophen-1-yl, dimethylcyclopentadienyl titanium bis-2,3,5,6-tetrafluorophen-1-yl, dimethylcyclopentadienyl titanium bis-2,4-difluorophen-1-yl, bis-(cyclopentadienyl)-bis(2,6-difluoro-3-(pyrrol-1-yl)phenyl)titanium, bis(cyclopentadienyl)-bis[2,6-difluoro-3-(methyl-sulfonamido)phenyl]titanium, and bis(cyclopentadienyl)-bis[2,6-difluoro-3-(N-butylbiaroylamino)phenyl]titanium.

### 1.3.9 Active Esters

Examples of the active esters include nitrobenzyl esters disclosed in JP-A-60-198538 and iminosulfonates disclosed in JP-A-4-365048.

### 1.3.10 Carbon-Halogen Bond-Containing Compounds

Examples of the carbon-halogen bond-containing compounds include compounds disclosed in JP-A-53-133428.

The following initiators can be used herein: photoradical polymerization initiators, such as Vicure 10 and Vicure 30, available from Stauffer Chemical Co.; photoradical polymerization initiators, such as Irgacure 127, Irgacure 184, Irgacure 500, Irgacure 651, Irgacure 2959, Irgacure 907, Irgacure 369, Irgacure 379, Irgacure 754, Irgacure 1700, Irgacure 1800, Irgacure 1850, Irgacure 819, OXE 01, Darocur 1173, TPO, and ITX, available from Ciba Specialty Chemicals Inc.; photoradical polymerization initiators, such as Quantacure CTX, available from Aceto Chemical Co., Inc.; photoradical polymerization initiators, such as Kayacure DETX-S, available from Nippon Kayaku Co., Ltd.; and photoradical polymerization initiators, such as ESACURE KIP 150, available from Lamberti.

The content of the photopolymerization initiator in the photocurable composition is preferably about 0.05% to 10%, more preferably about 0.5% to 8%, and further more preferably about 1% to 6% on a weight basis. When the content thereof is less than 0.05% by weight, the photocurable composition has insufficient curability and therefore is insufficiently cured. When the content thereof is greater than 10% by weight, a cured product made from the photocurable composition has low strength because the degree of polymerization of the cured product is not sufficiently increased and therefore the cured product contains a large amount of low-molecular-weight components.

### 1.4 HALS

The photocurable composition further contains a hindered amine light stabilizer (HALS) serving as a polymerization inhibitor.

Examples of the HALS include, but are not limited to, bis(1,2,2,6,6-pentamethyl-4-piperidyl) sebacate; 1-{2-[3-(3,5-di-t-butyl-4-hydroxyphenyl)propionyloxy]ethy}-2,2,6,6-tetramethylpiperidine; 8-acetyl-3-dodecyl-7,7,9,9-tetramethyl-1,3,8-triazaspiro[4,5]decane-2,4-dione; HALSs described in The Chemical Daily Co., Ltd., 13700 Chemical Products, pp. 1069-1070, 2000; HALSs disclosed in the 1994 product catalogue of polymer stabilizer “SANOL” of Sankyo Co., Ltd.; and Irgastb UV-10 available from Ciba Specialty Chemicals Inc. These compounds may be used alone or in combination.

The content of the HALS in the photocurable composition is preferably about 0.05% to 0.5% by weight. The HALS is regenerative by oxidation-reduction reaction and therefore maintains its polymerization inhibitory activity. The above range of the content thereof is sufficient.

### 1.5 Chain Transfer Agent Containing Active Hydrogen

The photocurable composition may further contain a chain transfer agent containing active hydrogen. The presence of the chain transfer agent in the photocurable composition prevents oxygen from inhibiting polymerization to enhance the curability of the photocurable composition. The chain transfer agent is effective in enhancing the affinity of a cured product to bases made of glass, metal, PET, or the like.

The chain transfer agent has a functional group containing active hydrogen. Examples of the active hydrogen-containing functional group include an amino group, an amide group, a hydroxyl group, a sulfo group, and a thiol group. The chain transfer agent is not particularly limited except having the active hydrogen-containing functional group. The chain transfer agent is preferably a multifunctional group having a plurality of thiol groups. A preferred example of the chain transfer agent is Karenz® MT NR1 available from Showa Denko K.K.

The content of the chain transfer agent in the photocurable composition is preferably about 0.01% to 3% by weight.

### 1.6 Urethane Oligomer

The photocurable composition may further contain the urethane oligomer. The presence of the urethane oligomer in the photocurable composition allows a layer of a cured product made from the photocurable composition to have high strength and also allows the photocurable composition to have high curability.

The term “urethane oligomer” used herein means an oligomer having one or more urethane bonds and one or more radically polymerizable double bonds. The term “oligomer” used herein covers molecules which have a small number, usually two to 20, of repeating units substantially or conceptually obtained from molecules having a small relative molecular mass (substantially synonymous with a molecular weight) and which have a moderate relative molecular mass and is usually referred to as a photopolymerizable prepolymer, a base resin, or an acrylic oligomer.

The urethane oligomer has one or more acryloyl groups, which are functional groups, and therefore is characterized in that the urethane oligomer is polymerized with monomers or the like by light irradiation such that molecules of the urethane oligomer are crosslinked.

An example of the urethane oligomer is an oligomer obtained by the polyaddition of a polyisocyanate with a polyol or a polyhydroxy compound. Common examples of the urethane oligomer include polyester urethane acrylate oligomers, polyether urethane acrylate oligomers, polybutadiene urethane acrylate oligomers, and polyol urethane acrylate oligomers. Specific examples of the urethane oligomer include oligomers U-4HA and U-15HA available from Shin-Nakamura Chemical Co., Ltd.

The urethane oligomer preferably has a molecular weight of about 500 to 20,000 and more preferably about 500 to 10,000.

The content of the urethane oligomer in the photocurable composition is preferably about 1% to 70% and more preferably about 3% to 30% on a weight basis.

### 1.7 Surfactant

The photocurable composition may further contain a surfactant. Preferred examples of the surfactant include silicone surfactants such as polyester-modified silicones and ether-modified silicones. More preferred examples of the surfactant include polyether-modified dimethylsiloxanes and polyester-modified polydimethylsiloxanes. Specific examples of the surfactant include surfactants BYK-347, BYK-348, BYK-UV3500, BYK-UV3510, BYK-UV3530, and BYK-UV3570 available from Byk Chemie Japan K.K.

The content of the surfactant in the photocurable composition is preferably about 0.01% to 5% and more preferably about 0.05% to 3% on a weight basis.

### 1.8 Other Additives

The photocurable composition may further contain a known additive such as a humectant, an infiltration solvent, a pH adjustor, an antiseptic, or an antimildew agent. Furthermore, the photocurable composition may contain an additive such as a leveling agent or a matting agent and an additive, such as a polyester resin, a polyurethane resin, a vinyl resin, an acrylic resin, a rubber resin, or wax, for adjusting film properties.

### 2. Method for Forming Cured Product

A method for forming a cured product according to the present invention includes a step of applying the photocurable composition to a base and a step of irradiating the photocurable composition with light from a fluorescent lamp or an LED to cure the photocurable composition. An example of the cured product-forming method is described below.

(1) The base is prepared. The base is not particularly limited and may be made of a known material such as metal, paper, or plastic. The base may be film-shaped. Since the photocurable composition is cured by irradiating the photocurable composition with light from the fluorescent lamp or the LED as described below in detail, the thermal damage of the base can be greatly reduced. Therefore, the base may be made of a resin, such as polystyrene, polyethylene, polyethylene terephthalate, polycarbonate, polyacetal, polyvinyl chloride, or an acrylic resin, readily distorted by heat.

The photocurable composition is applied to the base. Examples of a process for applying the photocurable composition to the base include an ink jet recording process, a screen-printing process, a bar-coating process, a roll-coating process, a flow coating process, and a known process using an aerosol spray or a brush. In particular, the ink jet recording process is preferably used to apply the photocurable composition to the base. This is because the use of the ink jet recording process is effective in uniformly applying the photocurable composition to the base and allows the thickness of a layer to be readily adjusted.

Unlike the use of the screen-printing process, the use of the ink jet recording process allows oxygen to inhibit the curing of conventional photocurable compositions because the conventional photocurable compositions have a large contact area with air. In particular, radicals generated by ultraviolet irradiation do not function effectively at the interfaces between air and the conventional photocurable compositions. Even if the conventional photocurable compositions are irradiated with ultraviolet light for a long time, a large amount of oxygen in air inhibits the curing function of the generated radicals and therefore polymerization initiators contained in the conventional photocurable compositions are dissipated. This prevents the curing of the conventional photocurable compositions.

However, the photocurable composition contains the active hydrogen-containing polymerizable compound and therefore is highly active; hence, the curing of the photocurable composition is hardly inhibited by oxygen in air. Therefore, the ink jet recording process is preferably used in the cured product-forming method.

For the use of the ink jet recording process, the photocurable composition preferably has a viscosity of 10 mpa·s or less at 25° C.

In the ink jet recording process, an ink jet recording apparatus may be used. The ink jet recording apparatus includes a known discharging system such as an ink jet system for discharging ink using the driving pressure of a piezoelectric element or a thermal jet system for discharging ink using the pressure generated in such a manner that bubbles are formed and then expanded by heat.

(2) The photocurable composition, which is placed on the base, is irradiated with light from the fluorescent lamp or the LED, whereby the photocurable composition is cured.

The term “fluorescent lamp” used herein means a light source using a phosphor having a capability to absorb ultraviolet light, generated by arc discharge in a low-pressure mercury vapor in a glass tube, having a wavelength of 253.7 nm to convert the ultraviolet light into fluorescent light having another wavelength and therefore excludes sterilizing lamps, low-pressure mercury lamps, high-pressure mercury lamps, ultrahigh-pressure mercury lamps, and metal halide lamps that do not convert ultraviolet light.

The fluorescent lamp is a non-white fluorescent lamp that absorb ultraviolet light having a wavelength of 253.7 nm to convert the ultraviolet light into light having a specific wavelength and an amplified energy. Examples of the fluorescent lamp include color fluorescent lamps, black-light fluorescent lamps, and photochemical fluorescent lamps. Preferred examples of the color fluorescent lamps include blue fluorescent lamps, FL20SB and FL40SB, available from Toshiba Lighting & Technology Corporation and blue-white fluorescent lamps, FL20SBW and FL40SBW, available from Toshiba Lighting & Technology Corporation. The black-light fluorescent lamps are light sources that hardly emit visible light but efficiently emit near-ultraviolet light having a strong scintillation effect and a peak wavelength of 352 nm. Preferred examples of the black-light fluorescent lamps include fluorescent lamps, FL20SBLB and FL40SBLB, available from Toshiba Lighting & Technology Corporation. The photochemical fluorescent lamps are light sources that generate near-ultraviolet radiations having a wavelength of around 360 nm. Examples of the photochemical fluorescent lamps include fluorescent lamps, FL20SBL-360 and FL40SBL-360, available from Mitsubishi Electric Osram Ltd.

The LED, which can be used in the cured product-forming method, has an emission peak wavelength of 350 nm or more.

The LED may include two or more types of elements having different emission peak wavelengths greater than or equal to 350 nm.

An example of the LED, which has an emission peak wavelength of 350 nm or more, is an ultraviolet light-emitting diode (UV-LED), NCCU-033, available from Nichia Corporation.

The LED preferably includes two or more types of elements having different emission peak wavelengths greater than or equal to 350 nm as described above. This allows the photocurable composition to be cured in a short time even if the LED has low output power.

The fluorescent lamp and the LED preferably have a power consumption of about 10 to 100 W and more preferably about 20 to 60 W. When the power consumption of the fluorescent lamp or the LED is within the above range, the photocurable composition can be cured in such a manner that the photocurable composition is irradiated with light from the fluorescent lamp or the LED for about one to ten minutes. The light emitted from the fluorescent lamp or the LED has low energy and therefore does not thermally damage the base.

The term “to thermally damage the base” used herein means that the base is supplied with thermal energy by light irradiation such that the surface temperature thereof is increased to 50° C. or more. Since the fluorescent lamp or the LED, which has the above power consumption, is used, the surface temperature of the base can be maintained at less than 50° C. Since the surface temperature of the base can be maintained at less than 50° C., the base may be made of a material, such as polyvinyl chloride (PVC) having a softening point of about 70° C. or polyethylene terephthalate (PET) having a glass transition point of about 69° C., sensitive to heat.

Advantages of the cured product-forming method are as described below.

It takes about 15 minutes until the low-pressure mercury lamps, the high-pressure mercury lamps, the ultrahigh-pressure mercury lamps, and the metal halide lamps emit light. Furthermore, it takes about five to ten minutes until the outputs of these lamps are stable. Therefore, these lamps are unsuitable for use in devices that are switched on or off as required. On the other hand, the fluorescent lamp and the LED emit light immediately after being switched on. Therefore, the fluorescent lamp and the LED are available for on-demand use.

For these lamps, 50% or more of the energy consumed thereby is dissipated as infrared radiation or heat loss, which may thermally damage the base. Therefore, a cooling unit for preventing the thermal damage of the base needs to be used. This causes a problem in that a system including the cooling unit has a large size. On the other hand, the use of the fluorescent lamp or the LED requires no cooling unit. This allows a system including the fluorescent lamp or the LED to have a reduced size.

These lamps may emit strong ultraviolet light, which is harmful to humans. Therefore, tools, such as shielding plates, for blocking strong ultraviolet light need to be used. On the other hand, the fluorescent lamp and the LED are used for indoor lighting and have no adverse affects on humans. Therefore, any tool such as a shielding plate need not be used. This leads to size reduction.

The cured product, which is obtained by the cured product-forming method, is transparent and colorless and is useful in treating a base sensitive to heat. In particular, the cured product is useful in bonding an optical element such as a lens; a plastic sheet such as an acrylic sheet, a PVC sheet, or a PET sheet; or the like to another material. The cured product has low curing shrinkage and therefore can be used to precisely bond such an optical element or a plastic sheet.

### 3. EXAMPLE

The present invention is further described in detail with reference to examples below. The present invention is not limited to the examples.

### 3.1 Preparation of Photocurable Compositions

The following components were weighed such that compositions shown in Table 1 were obtained: a polymerizable monomer, a dendritic polymer, a photopolymerization initiator, a HALS, a surfactant, and the like. The components were mixed for one hour at room temperature, whereby thoroughly mixed blends were obtained. The blends were filtered through a 5-μm screen, whereby Photocurable Compositions 1 to 9 shown in Table 1 were prepared.

TABLE 1

| | | Photocurable Compositions | | | | | | | | |
|---|---|---|---|---|---|---|---|---|---|---|
| Components | Compounds | 1 | 2 | 3 | 4 | 5 | 6 | 7 | 8 | 9 |
| Polymerizable | Ethylene glycol | 72.2 | 72.1 | 72.15 | 79.6 | — | — | 87.1 | 77.1 | 72.3 |
| monomers | monoallyl ether | | | | | | | | | |
| | Tripropylene | — | — | — | — | — | 79.7 | — | — | — |
| | glycol diacrylate | | | | | | | | | |
| Dendritic polymer | Viscoat #1000 | 15.0 | 15.0 | 15.0 | 15.0 | 30.0 | 15.0 | — | 15.0 | 15.0 |
| Urethane oligomer | U-15HA | 7.5 | 7.5 | 7.5 | — | 64.6 | — | 7.5 | 7.5 | 7.5 |
| Photopolymerization | Irgacure 819 | 4.0 | 4.0 | 4.0 | 4.0 | 4.0 | 4.0 | 4.0 | — | 4.0 |
| initiators | Irgacure 127 | 1.0 | 1.0 | 1.0 | 1.0 | 1.0 | 1.0 | 1.0 | — | 1.0 |
| Surfactant | BYK UV3570 | 0.1 | 0.1 | 0.1 | 0.1 | 0.1 | 0.1 | 0.1 | 0.1 | 0.1 |
| HALS | Irgastab UV-10 | 0.2 | 0.2 | 0.2 | 0.2 | 0.2 | 0.2 | 0.2 | 0.2 | — |
| Chain transfer | Karenz MT NR1 | — | 0.1 | 0.05 | 0.1 | 0.1 | — | 0.1 | 0.1 | 0.1 |
| agent | | | | | | | | | | |

The components shown in Table 1 were as described below. A polymerizable monomer, containing active hydrogen, used was ethylene glycol monoallyl ether available from Nippon Nyukazai Co., Ltd. A polymerizable monomer, containing no active hydrogen, used was tripropylene glycol diacrylate available from Shin-Nakamura Chemical Co., Ltd. A dendritic polymer used was Viscoat #1000 available from Osaka Organic Chemical Industry Ltd. A urethane oligomer, containing active hydrogen, used was U-15A available from Shin-Nakamura Chemical Co., Ltd. Photopolymerization initiators used were Irgacure 819 and Irgacure 127 available from Ciba Specialty Chemicals Inc. A surfactant (surface conditioner), containing a polyester-modified polydimethylsiloxane containing an acrylic group, used was BYK-UV3570 available from Byk Chemie Japan K.K. A HALS (thermoradical polymerization inhibitor) used was Irgastb UV-10 available from Ciba Specialty Chemicals Inc. A chain transfer agent, containing active hydrogen originating from a multifunctional thiol, used was Karenz MT NR1 available from Showa Denko K.K. Values in Table 1 are in weight percent.

### 3.2 Curability Evaluation (1)

Photocurable Composition 1 shown in Table 1 was applied to bases using an ink jet printer, PX-900G, available from Seiko Epson Corporation. The bases were a PVC sheet, SPVC-G-1270T, available from Roland DG Corporation; a PET sheet, Lumirror S10, available from Toray Industries Inc.; a transparent acrylic resin sheet available from As One Corporation; and a PC sheet, Iupilon FE-2000, available from Mitsubishi Engineering-Plastics Corporation.

The time taken to completely cure Photocurable Composition 1 was measured in such a manner that a surface of each base that carried the Photocurable Composition 1 was irradiated with light from one of light sources shown in Table 2 or 3 at room temperature (about 25° C.). Resulting Photocurable Composition 1 was then visually evaluated for curability. Standards for curability evaluation were as described below. The energy dissipated for curing Photocurable Composition 1 was calculated from the type of each light source and the time taken to completely cure Photocurable Composition 1.

Standards for Curability Evaluation

A: Cured with no defect and tack-free

B: Partly cured and tacky due to the presence of uncured portions

C: Not cured at all

The surface temperature of the base was measured with a radiation thermometer immediately after Photocurable Composition 1 was completely cured. The base was visually evaluated for surface damage. Standards for surface damage evaluation were as described below.

Standards for Surface Damage Evaluation

A: No defect in appearance, or defect-free

B: Permanently damaged due to heat

The evaluation results were as shown in Tables 2 and 3.

TABLE 2

| | Examples | | |
|---|---|---|---|
| | 1 | 2 | 3 |
| Light source | Blue | Black light | UV-LED |
| | fluorescent | (FL20S-BLB) | (NCCU-033) |
| | lamp | | |
| | (FL20S-B) | | |
| Time taken for curing | 540 | 330 | 180 |
| (s) | | | |
| Energy dissipated for | 3.21 × 10⁶ | 14.4 | 180 |
| curing | (lx · s) | (mJ/cm²) | (J/cm²) |
| Energy per unit area | 25.7 | 15.7 | 108 |
| consumed by light | | | |
| source (J/cm²) | | | |
| Surface temperature of | 25 | 25 | 38 |
| base (° C.) | | | |
| Curability evaluation | A | A | A |
| Surface damage of base | | | |
| by curing | | | |
| PVC sheet | A | A | A |
| PET sheet | A | A | A |
| Acrylic resin sheet | A | A | A |
| PC sheet | A | A | A |

TABLE 3

| | Comparative Examples | | |
|---|---|---|---|
| | 1 | 2 | 3 |
| Light source | Metal halide | Metal halide | Not |
| | lamp | lamp | used |
| | (Subzero-055) | (S400-C1-TH1A) | |
| Time taken for | 30 | 10 | Not |
| curing (s) | | | cured |
| Energy dissipated | 6,600 | 4,320 | 0 |
| for curing | (mJ/cm²) | (mJ/cm²) | (J/cm²) |
| Energy per unit area | 375 | 640 | 0 |
| consumed by light | | | |
| source (J/cm²) | | | |
| Surface temperature | Higher than | Higher than 60 | 25 |
| of base (° C.) | 60 | | |
| Curability | A | A | C |
| evaluation | | | |
| Surface damage of | | | |
| base by curing | | | |
| PVC sheet | B | B | — |
| PET sheet | B | B | — |
| Acrylic resin sheet | B | B | — |
| PC sheet | B | B | — |

The light sources and irradiation conditions used in Examples 1 to 3 and Comparative Examples 1 and 2 were as described below.

### Example 1

Light source: Blue fluorescent lamp, FL20S-B, available from Toshiba Lighting & Technology Corporation

Power consumption: 20 W

Irradiation area: 7 cm×60 cm

Irradiation time: Ten minutes

### Example 2

Light source: Black light, FL20S-BLB, available from Toshiba Lighting & Technology Corporation

Power consumption: 20 W

Irradiation area: 7 cm×60 cm

Irradiation time: Six minutes

### Example 3

Light source: UV-LED, NCCU-033, available from Nichia Corporation

Power consumption: 60 W

Irradiation area: 5 cm×20 cm

Irradiation time: Three minutes

### Comparative Example 1

Light source: Metal halide lamp, Subzero-055, available from Integration Technology, Inc.

Power consumption: 500 W

Irradiation area: 5 cm×8 cm

Irradiation time: 30 seconds

### Comparative Example 2

Light source: Metal halide lamp, UW System S400-C1-TH1A, available from GS Yuasa Lighting Corporation

Power consumption: 6.4 kW

Irradiation area: 5 cm×20 cm

Irradiation time: Ten seconds

In Examples 1 to 3, although it took a long time, 180 to 540 seconds, to cure Photocurable Composition 1, Photocurable Composition 1 was completely cured. The surface temperature of each base was 25° C. to 38° C., that is, the surface temperature thereof was hardly or only slightly increased; hence, the base was not thermally damaged.

In Comparative Examples 1 and 2, Photocurable Composition 1 was completely cured in a short time, 10 to 30 seconds. The surface temperature of each base exceeded 60° C.; hence, the base was permanently damaged.

### 3.3 Curability Evaluation (2)

Photocurable Compositions 2 to 9 shown in Table 1 were applied to bases using an ink jet printer, PX-900G, available from Seiko Epson Corporation. The bases were PVC sheets, SPVC-G-1270T, available from Roland DG Corporation.

Photocurable Compositions 2 to 9 on the bases were irradiated with light from a blue fluorescent lamp, FL20S-B, available from Toshiba Lighting & Technology Corporation for ten minutes at room temperature (about 25° C.). Resulting Photocurable Compositions 2 to 9 were visually evaluated for curability. Standards for curability evaluation were the same as those described above. The evaluation results were as shown in Table 4.

TABLE 4

| | Examples | | | | Comparative Examples | | | |
|---|---|---|---|---|---|---|---|---|
| | 4 | 5 | 6 | 7 | 4 | 5 | 6 | 7 |
| Photocurable | 2 | 3 | 4 | 5 | 6 | 7 | 8 | 9 |
| Compositions | | | | | | | | |
| Curability | A | A | A | A | B | B | C | B |
| evaluation | | | | | | | | |

Photocurable compositions 2 to 5, which were used in Examples 4 to 7, respectively, contained the dendritic polymer, the polymerizable monomer containing active hydrogen, the polymerization initiator, and the HALS and therefore had good curability.

On the other hand, Photocurable compositions 6 to 9, which were used in Comparative Examples 4 to 7, respectively, lacked any one of the dendritic polymer, the polymerizable monomer containing active hydrogen, the polymerization initiator, and the HALS and therefore had insufficient curability.

### 3.4 Curability Evaluation (3)

Photocurable Compositions 2 to 9 shown in Table 1 were applied to bases using an ink jet printer, PX-900G, available from Seiko Epson Corporation. The bases were PVC sheets, SPVC-G-1270T, available from Roland DG Corporation.

Photocurable Compositions 2 to 9 on the bases were irradiated with light from a black light, FL20S-BLB, available from Toshiba Lighting & Technology Corporation for six minutes at room temperature (about 25° C.). Resulting Photocurable Compositions 2 to 9 were visually evaluated for curability. Standards for curability evaluation were the same as those described above. The evaluation results were as shown in Table 5.

TABLE 5

| | Examples | | | | Comparative Examples | | | |
|---|---|---|---|---|---|---|---|---|
| | 8 | 9 | 10 | 11 | 8 | 9 | 10 | 11 |
| Photocurable | 2 | 3 | 4 | 5 | 6 | 7 | 8 | 9 |
| Compositions | | | | | | | | |
| Curability | A | A | A | A | B | B | C | B |
| evaluation | | | | | | | | |

Photocurable compositions 2 to 5, which were used in Examples 8 to 11, respectively, contained the dendritic polymer, the polymerizable monomer containing active hydrogen, the polymerization initiator, and the HALS and therefore had good curability.

On the other hand, Photocurable compositions 6 to 9, which were used in Comparative Examples 8 to 11, respectively, lacked any one of the dendritic polymer, the polymerizable monomer containing active hydrogen, the polymerization initiator, and the HALS and therefore had insufficient curability.

### 3.5 Curability Evaluation (4)

Photocurable Compositions 2 to 9 shown in Table 1 were applied to bases using an ink jet printer, PX-900G, available from Seiko Epson Corporation. The bases were PVC sheets, SPVC-G-1270T, available from Roland DG Corporation.

Photocurable Compositions 2 to 9 on the bases were irradiated with light from a UV-LED, NCCU-033, available from Nichia Corporation for three minutes at room temperature (about 25° C.). Resulting Photocurable Compositions 2 to 9 were visually evaluated for curability. Standards for curability evaluation were the same as those described above. The evaluation results were as shown in Table 6.

TABLE 6

| | Examples | | | | Comparative Examples | | | |
|---|---|---|---|---|---|---|---|---|
| | 12 | 13 | 14 | 15 | 12 | 13 | 14 | 15 |
| Photocurable | 2 | 3 | 4 | 5 | 6 | 7 | 8 | 9 |
| Compositions | | | | | | | | |
| Curability | A | A | A | A | B | B | C | B |
| evaluation | | | | | | | | |

Photocurable compositions 2 to 5, which were used in Examples 12 to 15, respectively, contained the dendritic polymer, the polymerizable monomer containing active hydrogen, the polymerization initiator, and the HALS and therefore had good curability.

On the other hand, Photocurable compositions 6 to 9, which were used in Comparative Examples 12 to 15, respectively, lacked any one of the dendritic polymer, the polymerizable monomer containing active hydrogen, the polymerization initiator, and the HALS and therefore had insufficient curability.

The present invention is not limited to the above embodiments. Various modifications may be made within the scope of the present invention. The present invention covers any configurations (identical in, for example, function, method, result, purpose, and/or advantage to those described in the embodiments) substantially identical to those described in the embodiments. The present invention covers any configurations capable of achieving substantially the same advantages or purposes as those described in the embodiments. Furthermore, the present invention covers any configurations obtained by combining the configurations described in the embodiments with known techniques.

What is claimed is:

1. A method for forming a cured product, comprising:
applying a photocurable composition to a base; and
irradiating the photocurable composition with light from a light source to cure the photocurable composition, the light source being at least one of a fluorescent lamp and a light-emitting diode,
wherein the photocurable composition contains a dendritic polymer, a polymerizable compound containing active hydrogen, a photopolymerization initiator, and a hindered amine light stabilizer.

2. The method according to claim 1, wherein the photocurable composition is applied to the base by an ink jet recording process.

3. The method according to claim 1, wherein the fluorescent lamp is a non-white fluorescent lamp that amplifies a specific wavelength.

4. The method according to claim 1, wherein the fluorescent lamp is at least one selected from the group consisting of a color fluorescent lamp, a black-light fluorescent lamp, and a photochemical fluorescent lamp.

5. The method according to claim 1, wherein the surface temperature of the base is lower than 50° C.

6. The method according to claim 1, wherein a material for forming the base is selected from the group consisting of polyvinyl chloride, polyethylene terephthalate, an acrylic resin, and polycarbonate.

7. The method according to claim 1, wherein the photocurable composition further contains a chain transfer agent containing active hydrogen.

8. A cured product produced by the method according to claim 1.
